(19) United States
(12) Patent Application Publication
(10) Pub. No.: US 2011/0076648 A1
(43) Pub. Date: Mar. 31, 2011

(54) Simulation system

(75) Inventors: Richard D. Lindheim, Beverly Hills, CA (US); David B. Wertheimer, Los Angeles, CA (US); Robert Wolterstorff, Pacific Palisades, CA (US); Monty Lunde, Valencia, CA (US); Craig Barr, La Crescenta, CA (US)

(73) Assignee: RL Leaders, LLC

(21) Appl. No.: 12/586,657

(22) Filed: Sep. 25, 2009

(51) Int. Cl. G09B 9/02; G06G 7/70; H04N 5/265; G09B 9/30; G09B 9/05; G09B 9/06

(52) U.S. Cl. 434/38; 703/8; 348/584; 434/29; 434/69; 348/E05.056

(57) ABSTRACT

A simulation system provides a simulated environment to at least one user in a simulation area. The simulation system includes a video system configured to provide high definition video of the simulated environment across a field of view of the user. The video system provides high definition live action video. The simulation system also includes an audio system configured to provide high definition audio related to the provided high definition video of the simulated environment and a motion system configured to move the at least one user on x, y, and z axes to simulate movement in the simulated environment.

### STATEMENT OF GOVERNMENT RIGHTS

This invention was made with Government support under Contract Number W91260-06-D-0005 awarded by the U.S. Army Space and Missile Defense Command/Army Forces Strategic Command. The Government has certain rights in this invention.

### BACKGROUND

The present invention relates generally to the field of simulation systems and methods and more specifically to simulation systems and methods combining audio, video, and motion components.

Conventional simulation systems are generally configured to provide a user with audio and computer generated visual components of an environment being simulated. These simulation systems are often from the perspective of the user operating a vehicle. Some simulation systems also include a motion component and move a vehicle the user is seated in with respect to the computer generated video displayed. Some simulation systems can be used for civilian or military training, for example on how to operate a land, air, or sea vehicle.

Improvised explosive devices (IED) (e.g., roadside bombs) are a concern for military and civilian personnel alike. Such improvised devices are often constructed using common household objects and can be difficult to detect. It is difficult to simulate how to detect and avoid such improvised devices, for example while traveling in a vehicle, using conventional simulators because the realism of the simulation is not great enough to capture what these threats look like or in what environments they are typically found.

What is needed is a simulation system and method for providing a more realistic and immersive simulation. What is also needed is a simulation system and method for providing more realistic and immersive visuals, audio, and motion. What is also needed is a simulation system and method for better preparing soldiers for conditions they may face in theater. What is further needed is simulation system and method that can provide knowledge to a soldier to hone his or her skills at threat detection, for example to train him or her to overcome and remain effective in an IED event.

### SUMMARY

One embodiment of the disclosure relates to a simulation system providing a simulated environment to at least one user in a simulation area. The simulation system includes a video system configured to provide high definition video of the simulated environment across a field of view of the user. The video system provides high definition live action video. The simulation system also includes an audio system configured to provide high definition audio related to the provided high definition video of the simulated environment and a motion system configured to move the at least one user on x, y, and z axes to simulate movement in the simulated environment.

Another embodiment of the disclosure relates to a simulator for providing a simulated training environment to at least one user in a simulation vehicle. The simulator includes a video system configured to provide high definition video of the simulated environment at across a field of view of the user. The video system provides high definition live action video. The simulator also includes an audio system configured to provide high definition audio related to the provided high definition video of the simulated environment and a motion system configured to move the vehicle on x, y, and z axes to simulate movement in the simulated environment. The controller affects the simulation environment by controlling the simulation vehicle in response to verbal and/or non-verbal actions by the user. The motion system moves to simulate the vehicle traveling over terrain, the audio system provides vehicle audio, and the video system provides video based on user control of the vehicle.

Another embodiment of the disclosure relates to an apparatus for providing a simulated environment to at least one user in a simulation area. The apparatus includes means for providing high definition video of the simulated environment across a field of view of the user. The high definition video includes live action video. The apparatus also includes means for providing high definition audio related to the provided high definition video of the simulated environment and means for moving the at least one user on x, y, and z axes to simulate movement in the simulated environment.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of a simulation system according to an exemplary embodiment.

FIG. 2 is a partially transparent perspective view of the simulation system of FIG. 1 in an enclosure according to an exemplary embodiment.

FIG. 3 is a top schematic view of the simulation system of FIG. 1 according to an exemplary embodiment.

FIG. 4 is a perspective view of the simulation system of FIG. 1 in an enclosure according to an exemplary embodiment.

FIG. 5 is a perspective view of the vehicle mounted on a motion system according to an exemplary embodiment.

FIG. 6 is perspective view of the motion system of FIG. 5 with a side portion elevated according to an exemplary embodiment.

FIG. 7 is a front view of the vehicle and motion system of FIG. 5 tilted to a first side according to an exemplary embodiment.

FIG. 8 is a front view of the vehicle and motion system of FIG. 5 tilted to a second side according to an exemplary embodiment.

FIG. 9 is a front perspective view of the vehicle and motion system of FIG. 5 tilted to a first side according to an exemplary embodiment.

FIG. 10 is a rear perspective view of the vehicle and motion system of FIG. 5 tilted to a first side according to an exemplary embodiment.

FIG. 11 is a side view of the vehicle and motion system of FIG. 5 tilted to a first side according to an exemplary embodiment.

FIG. 12 is a side view of the vehicle and motion system of FIG. 5 tilted to a second side according to an exemplary embodiment.

FIG. 13 is a side view of the vehicle and motion system of FIG. 5 changing elevation according to an exemplary embodiment.

FIG. 14 is a top view of the vehicle and motion system of FIG. 5 rotating in a first direction according to an exemplary embodiment.

FIG. 15 is a top view of the vehicle and motion system of FIG. 5 rotating in a second direction according to an exemplary embodiment.

### DETAILED DESCRIPTION OF THE EXEMPLARY EMBODIMENTS

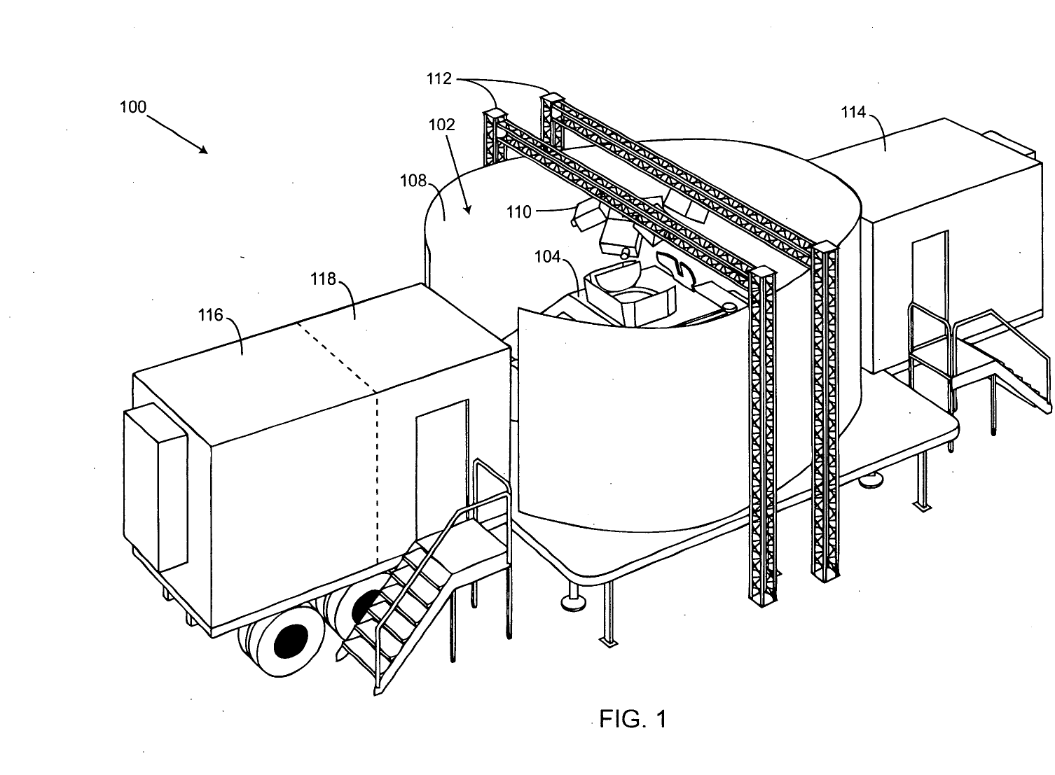

Referring to FIG. 1, according to various exemplary embodiments, a simulation system or simulator 100 may be configured to provide a realistic and immersive simulation environment to a user, for example realistic and immersive visuals, audio, and motion. According to some exemplary embodiments, simulation system 100 may be used for training and preparation of soldiers for conditions they may face in theater, for example for heightening soldiers' situational awareness and their ability to identify possible IED threats. Simulation system 100 may allow the soldiers (e.g., a team of soldiers) to experience a simulated yet realistic IED event.

Simulation system 100 is generally configured to be portable. For example, except for a power source, simulation system 100 may be self-contained (e.g., as a tractor trailer) and can be pulled by a conventional tractor truck. This portability may provide great flexibility. Simulation system 100 can be mounted or housed in a custom trailer. A custom sized trailer allows for flexibility in being able to use variously sized vehicles for the simulation. FIG. 1 illustrates a middle portion of simulation system 100 as being unpacked, but for transporting, this middle portion can be folded or packed into the trailer.

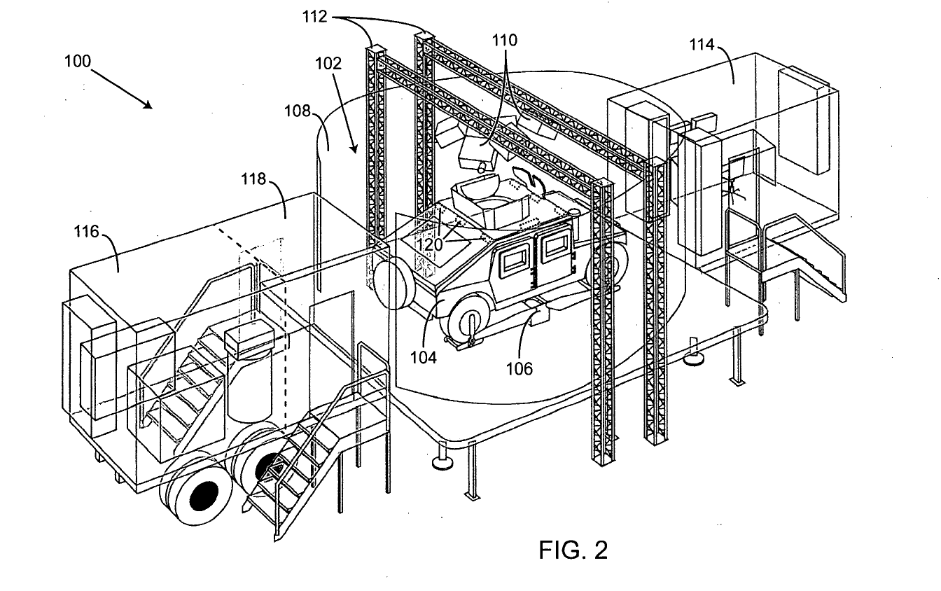

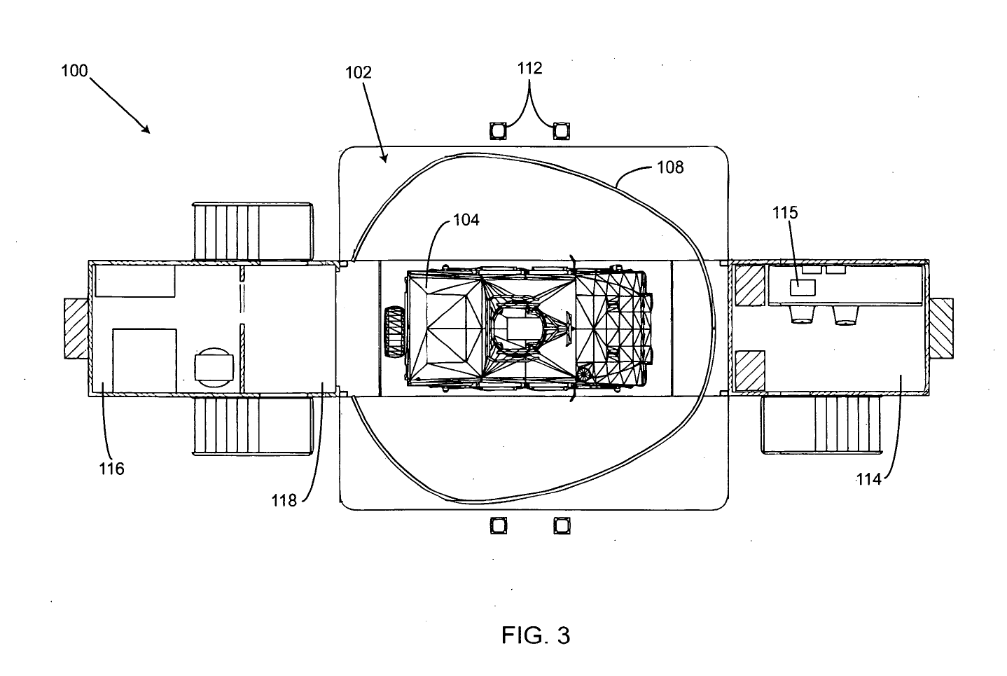

Referring also to FIGS. 2 and 3, simulation system 100 generally includes a simulation area 102 including a vehicle 104 that is mounted on a motion system or motion platform 106. The vehicle of the illustrated exemplary embodiment is an 1151 up-armored HMMWV or Humvee, however according to other exemplary embodiments, vehicle 104 may be any land, air, or sea vehicle capable of being simulated. Vehicle 104 may include any controls that would be included in a vehicle used in the field. The controls may communicate with simulation system 100 to affect what is displayed or heard or how motion system 106 moves.

Motion system 106 is generally configured to move vehicle 104 on various axes to simulate the movement of a real vehicle as it travels over terrain and to simulate affects of an IED explosion. Motion system 106 may be configured to move vehicle 104 on x, y, and z axes; that is vertically, horizontally, longitudinally, rocking the vehicle forward, backward, or to either side, or any combination thereof in response to the driver's commands, terrain, obstacles, and/or explosions.

Vehicle 104 is at least partially surrounded by a screen 108 that is configured to receive projected high definition images from at least one projector 110. According to various exemplary embodiments, screen 108 may be of an appropriate size to provide about a 270 degree field of view, about a 360 degree field of view, a field of view less than about 270 degrees, or a field of view between about 270 degrees and about 360 degrees for any occupants of vehicle 104 (e.g., driver, front passenger, rear passengers, gunner, etc.). According to still other exemplary embodiments, the screen may provide fields of view extended in the vertical axis, for example in a hemispherical, conical, or domed shape or any portion thereof. Screen 108 may be any screen of past, present, or future design capable of receiving and displaying video images.

Projectors 110 are mounted to a rigging 112 above vehicle 104 and at a height sufficient for displaying images on screen 108. According to various exemplary embodiments, projectors 110 may be any projectors capable of providing a high definition video projection to screen 108. When multiple projectors are used, each of projectors 110 are generally configured to provide images of a portion of terrain or environment that does not overlap or that does not significantly overlap with the images of the portion provided by the neighboring projector. Rigging 112 can be any rigging capable of extending above vehicle 104 and supporting the weight of projectors 110. Rigging 112 can be stored in the trailer with projectors 110 for transportation. According to other exemplary embodiments, flat panel monitors (e.g., LCD monitors, plasma monitors, rear projection monitors, etc.) may be used instead of projectors 110 and screen 108. The flat panel monitors may be thin, curved displays capable of providing high definition resolutions.

Simulation system 100 also includes a control room 114 configured to control the audio, video, and/or motion of the simulation. An observer/controller can monitor the simulation via hidden, closed-circuit cameras and helmet cams for a trainee point of view. The observer/controller can observe the trainees' behaviors, both individually and as a group. The observer/controller can trigger various IED explosions. The soldiers, after entering vehicle 104, can proceed on their route and can be presented with a series of potential IED events. If they identify the threat and follow procedures correctly, they can proceed to the next incident. If they do not recognize the threat, the observer/controller can trigger the IED event. As the soldiers move forward, the complexity of the situations may increase, requiring greater knowledge and situational awareness. Control room 114 may provide mechanisms for the controller or trainer to choose the right path he or she would like the trainees to encounter at certain pre-determined decision points. Control room 114 generally includes processing electronics or computing electronics 115 configured to control the audio, video, and motion components of the simulation.

Simulation system 100 further includes mechanical room 116 and staging area 118. Mechanical room 116 is generally configured to house a hydraulic power unit (HPU), an HVAC system, an air compressor, a smoke distribution system, and/or a power distribution system to run simulation system 100 and emit 4-D effects and movement for simulation system 100. Mechanical room 116 may also include a work area to make nay necessary repairs and storage space to house spare parts, tools, etc.

Staging or pre-show area 118 is a space for the trainees that will be using simulation system 100 to gather and be briefed on the simulation, including the goals, safety, and overall experience they will receive from the training session. According to some exemplary embodiments, the simulation system 100 may also include a VIP area where ranking military personnel and visitors can watch the training session and hear what is going on via a television screen and speakers or headphones.

According to another exemplary embodiment, simulation system 100 may use a front half of a standard trailer to house control room 114 and mechanical room 116 for equipment of motion system 106 while a back half of the trailer may be soft-sided for transport.

Referring also to FIG. 4, at the location for simulation, an enclosure 200 (e.g., a portable aluminum enclosure or other enclosure) can be assembled to house simulation system 100 including vehicle 104 and to surround screen 108. According to some exemplary embodiments, simulation system 100 may not be a stand-alone training system. For example, soldiers entering the simulation system may generally have some training in identifying potential IED threats and training tactics and procedures (TTPs). Simulation system 100 can be used at a combat training center (CTC), such as the National Training Center or a home station for troops, to provide training for soldiers prior to a CTC rotation. Simulation system 100 can also be used in theater both as a training tool and as a mission rehearsal tool.

According to one exemplary embodiment, simulation system 100 may simulate an Afghanistan scenario, for example an out and back mission from Forward Operating Base (FOB) Scorpion to Fire Base Bravo in a geo-typical area of Kandahar Province. The unit may be briefed on the mission and given current IED Intel.

The Humvee (i.e., vehicle 104) takes a lead position and moves through the route traveling at overwatch speed. The first threat may be an observable culvert, for example. The culvert may be simple and designed for the group to easily identify and build confidence. After successfully handling that situation, the Humvee may proceed to non-IED events, for example sniper fire and a possible suicide vehicle-borne improvised explosive device (SVBIED) attack, which are designed to increase emotion.

The second potential IED hot spot may be a typical wadi that soldiers in Afghanistan face regularly. To avoid detonation, the Humvee crew may decide to avoid a choke point in the road and navigate around the obstacle. As they proceed to the next hotspots, the situations and TTPs become increasingly complex, for example including an Afghan village environment, a disabled truck, a hoax IED with a secondary device in the safe cover area, etc. Any of the situations and TTPs may be passed multiple times to train for change detection.

For each training group, the training session may end with an IED explosion, triggered by the observer/controller in control room 114 at his or her discretion. After the explosion, the crew can evacuate the vehicle to staging area 118 or a secondary training area, for example live-action training in enclosure 200 following the simulation. The trainees may move out or evacuate through one of the doors in the back or side of the trailer. The training session may be captured on video so the observer/controller may be able to rapidly compile an incident clip file and burn a DVD to be used in after-action review (AAR) following the exercise.

The scenario described above is only one scenario according to the various exemplary embodiments. The simulation system is modular so other levels and event combinations can be easily added, different scenarios and geographical locations can be used, and different vehicles can be used.

The various scenarios are presented with realistic visual, auditory, and sensory components. Once inside the vehicle, the users' views outside the vehicle are a combination of enveloping projection screen 108. According to various exemplary embodiments, actual live-action, high definition video footage is used as opposed to computer-generated images.

The video footage may be obtained by an array of video cameras placed side-by-side that can be mounted on a camera vehicle and gyro-stabilized to reduce jerks and bumps. The video cameras may be arranged to capture about 270 degrees of visibility, for example for simulations where trainees are be in the lead vehicle. According to other exemplary embodiments, the camera system can capture a full 360 degree field of view, between about 270 and about 360 degrees of visibility, or less than 270 degrees of visibility. According to still other exemplary embodiments, the camera system may capture fields of view extended in the vertical axis, for example in a hemispherical, conical, or domed shape or any portion thereof.

Inside vehicle 104 the view may be limited by pillars and other vehicle structures, but the gunner may be able to move around and see in different directions. According to one exemplary embodiment, a head-mounted display system with goggles may replace conventional field use goggle.

The video is presented in high-definition, however the driver and co-pilot may use binoculars as they do in standard practice. Modified binoculars may allow the users to see small objects at a distance as they would in the real world. The lenses in the binoculars can be modified to use less magnification power so the image seen through them is not “pixelized” when looking at screen 108.

Because the scenarios generally include a series of individual sequences, simulation system 100 may provide seamless or near seamless transitions from one sequence to another. For example, dust is a prevailing environmental condition in Afghanistan and Iraq. Therefore, simulation system 100 (e.g., the processing electronics 115 in control room 114) can use digitally created blowing dust to mask changes or transitions in sequences taking place in these regions. In other scenarios, different environmental conditions may be used for the transitions, for example fog, snow, rain, foliage, darkness, existing structures, lightning flashes or other sudden increases in light, etc.

The digital video system may also provide the ability for video changes. According to one exemplary embodiment, simulation system 100 (e.g., the processing electronics 115 in control room 114) can insert images into the existing video material. For example, if a nomad tent is desired at the base of the hill, it can be digitally inserted or superimposed. According to another exemplary embodiment, because the video is composed of segments joined together by transitions (e.g., dust transitions), simulation system 100 can modify, eliminate, add, or replace any segment. In this way the scenario can reflect current knowledge and TTP's. Any inserted images may be live-action or CGI images.

The sound component of simulation system 100 can be used in several ways. The sound component generally includes the sound of the engine and of vehicle 104 in motion. This sound can be provided by an array of speakers 120 mounted inside or outside the vehicle. While speakers 120 are illustrated as being in specific locations of vehicle 104, according to other exemplary embodiments speakers 120 may be located elsewhere within simulation system 100. Further any number of speakers 120 may be used in order to provide the most realistic audio output depending on the type of vehicle and environment. Speakers 120 may be either visible or hidden within vehicle 104. Speakers 120 may be any speakers capable of providing high definition audio (e.g., Dolby 5.1 digital audio).

The members of the team may be wearing headsets (e.g., vic-5 headsets) modified for simulation. The users may hear appropriate radio traffic generated by control room 114. The team may also use the radio headsets to communicate with one another and any other convoy vehicles. The observer/controller can also participate in the dialogue and issue injects to advance the action. Sound for the gunner can be provided by a special headset that is capable of delivering high definition audio (e.g., 5.1 Dolby digital surround sound) as well as the radio traffic.

Sound may be coupled to the type of IED event selected by the observer/controller. In addition to providing the noise of the explosion, ultra-low frequency subwoofers can provide a realistic pressure wave to significantly increase the impact of the event.

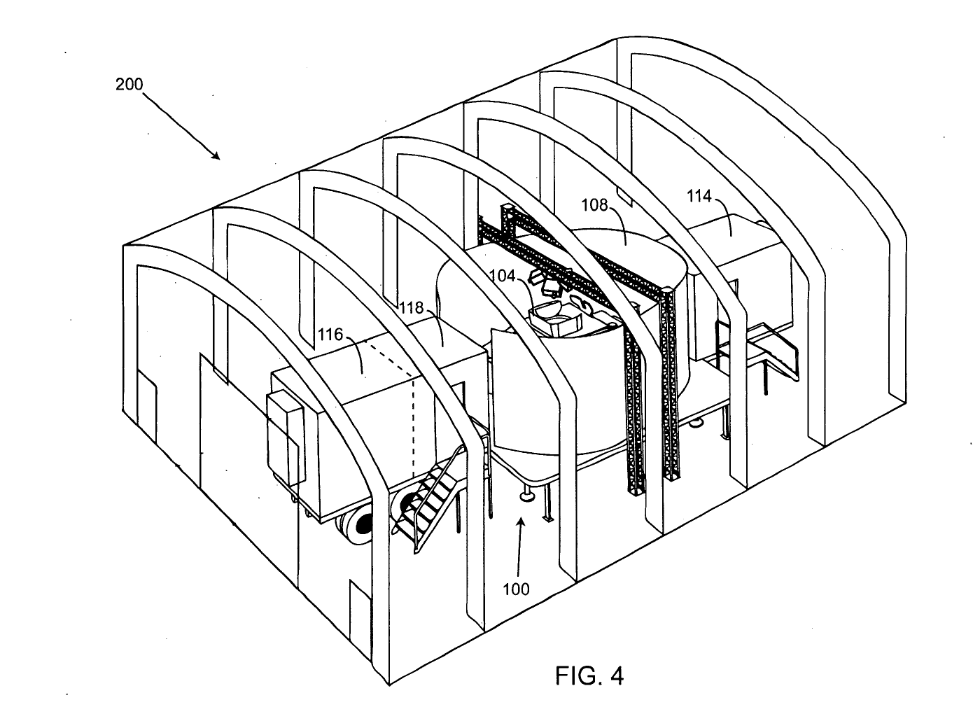

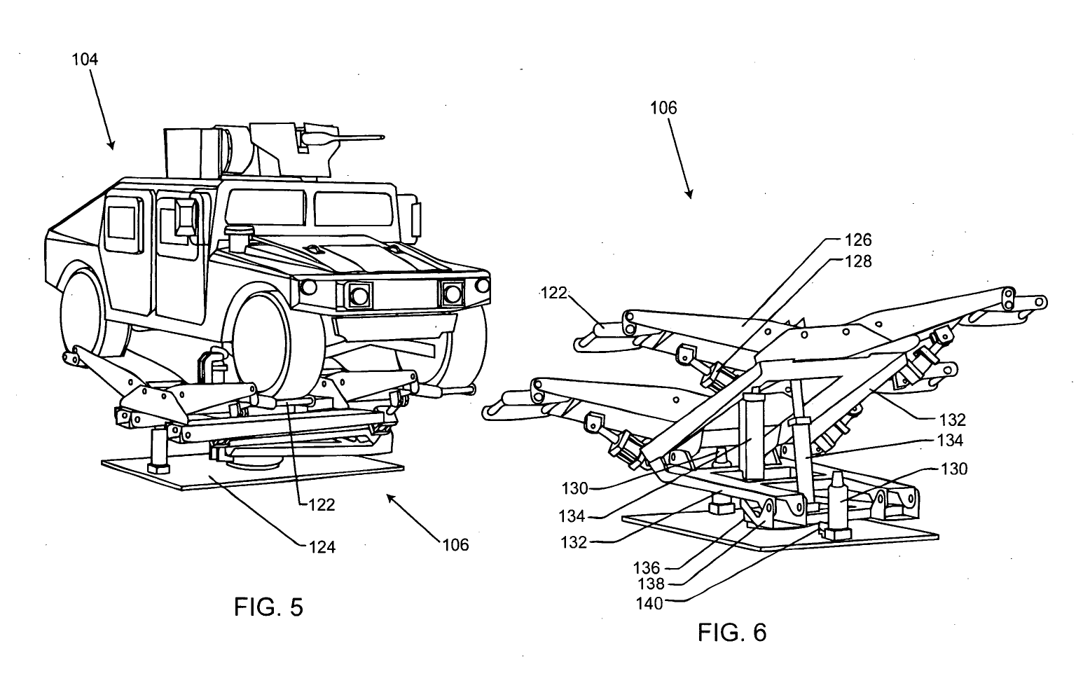

Referring also to FIGS. 5 and 6, the visual and audio components of the simulation can be synchronized with physical or motion effects by the processing electronics 115 of the control room 114. Motion platform or system 106 can simulate the movement of vehicle 104 in synchronization with the video material on screen 108. Vehicle 104 can bounce over the dirt roads and behave as the actual vehicle in motion. For IED explosions, simulation system 100 can combine blinding light, heat, and/or violent motion of vehicle 104 to realistically recreate the event. Soldiers may be thrown about and any gear not properly stowed or tied-down may become flying objects. Debris and other material may hit vehicle 104 and simulation area 102 can be occluded by smoke and dust. According to other exemplary embodiments, heat/air-conditioning or other environmental effects can be added to vehicle 104 or simulation areas 102 to heighten the impact of the climate or weather.

Motion system 106 generally secures or retains vehicle 104 with wheel straps around a wheel saddle 122 for each wheel of vehicle 104. Motion system 106 can be adjusted to fit and secure different vehicles of varying sizes. Vehicle 104 and motion system 106 are secured to a platform of the trailer using a base plate 124. Each wheel saddle 122 is coupled to a terrain actuation swing arm 126 that can be moved by a terrain actuation cylinder 128 in order to simulate changes in terrain texture and elevation. Both the driver and passenger sides of motion system 106 also include a descent shock absorber 130 to absorb shock when vehicle 104 is changing elevations. Both the driver and passenger sides of motion system 106 include an explosion actuation swing arm 130 that is quickly and abruptly moved by an explosion cylinder 132 to rock vehicle 104 and simulate an explosion event. Motion system 106 also includes a yaw rotational turret 136 that rotates vehicle 104 via a yaw swing arm 138, which I supported by a support roller 140.

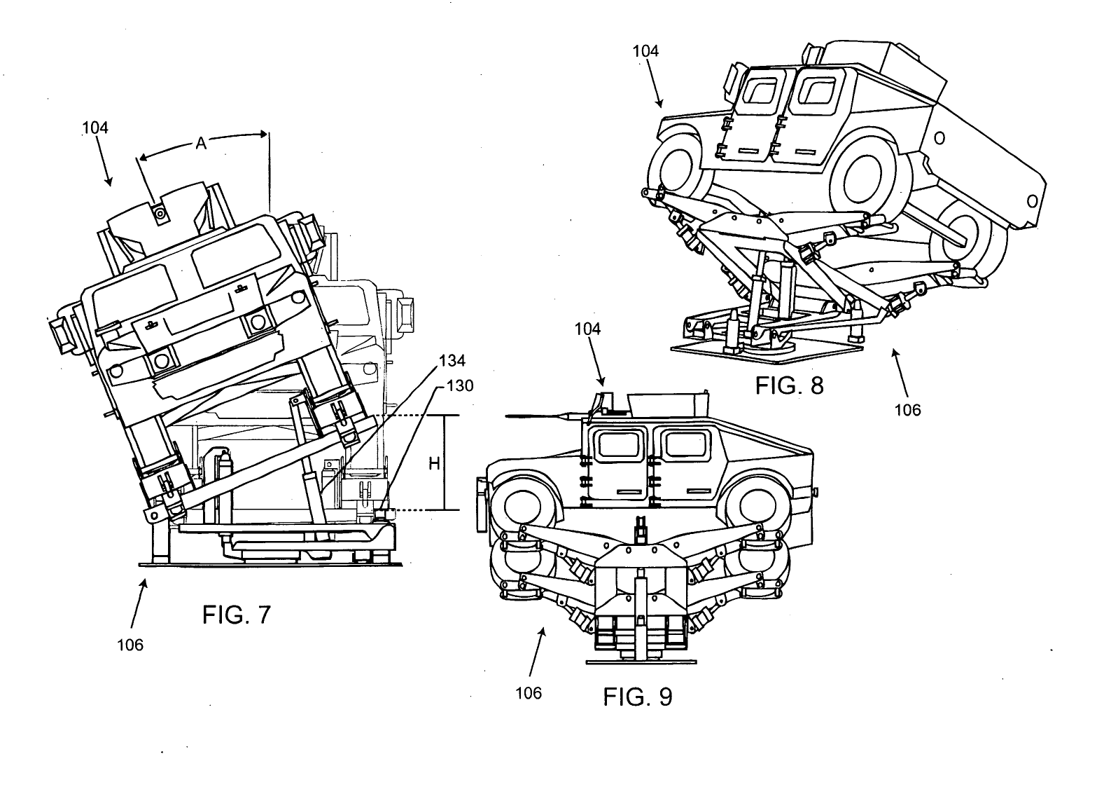

Referring to FIGS. 7-9, an event is illustrated where the driver side of vehicle 104 is raised by driver side cylinder 134, for example to simulate an explosion. The driver side may be lifted to a predetermined height H and angle A depending on the magnitude of explosion desired. Once vehicle 104 reaches height H or angle A, it may be dropped back to a normal position to simulate the vehicle dropping back to the ground. As vehicle 104 drops, driver side shock absorber 130 absorbs much of the impact so the simulation vehicle is not damaged.

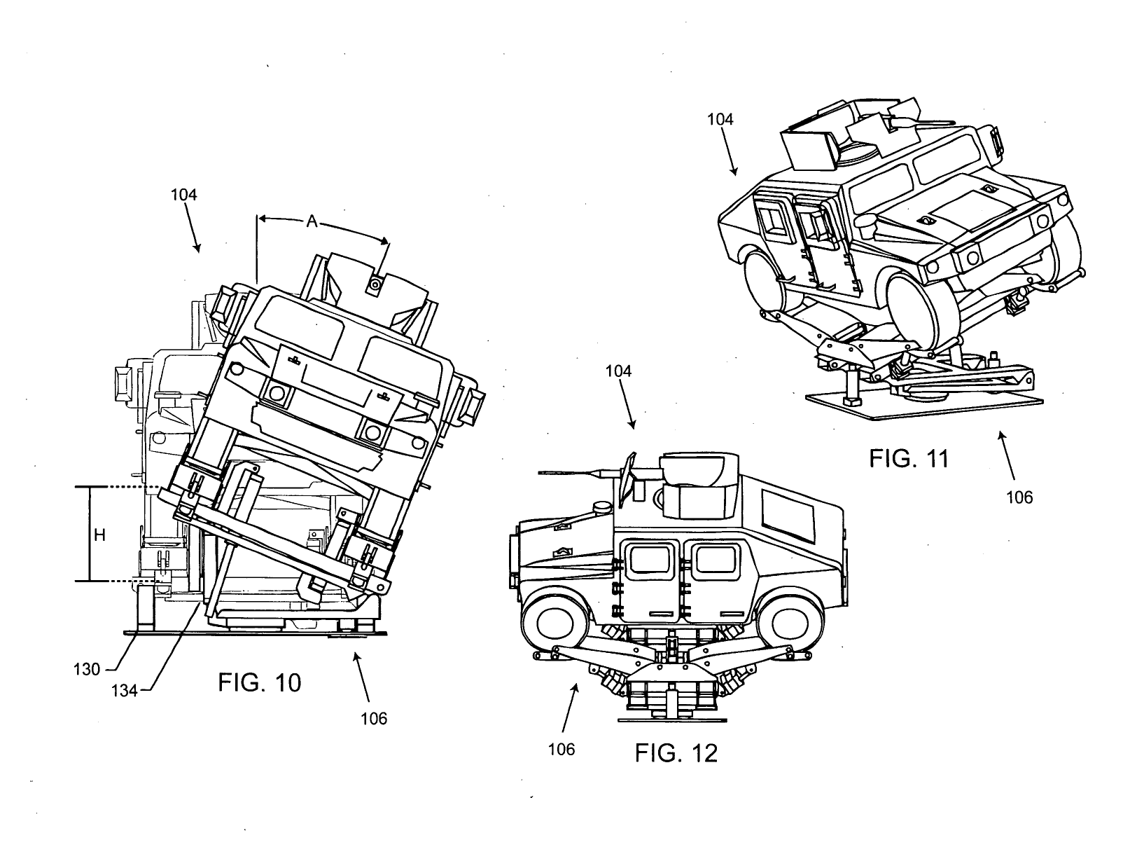

Referring to FIGS. 10-12, an event is illustrated where the passenger side of vehicle 104 is raised by passenger side cylinder 134, for example to simulate an explosion. The passenger side may be lifted to a predetermined height H and angle A depending on the magnitude of explosion desired. Once vehicle 104 reaches height H or angle A, it may be dropped back to a normal position to simulate the vehicle dropping back to the ground. As vehicle 104 drops, passenger side shock absorber 130 absorbs much of the impact so the simulation vehicle is not damaged.

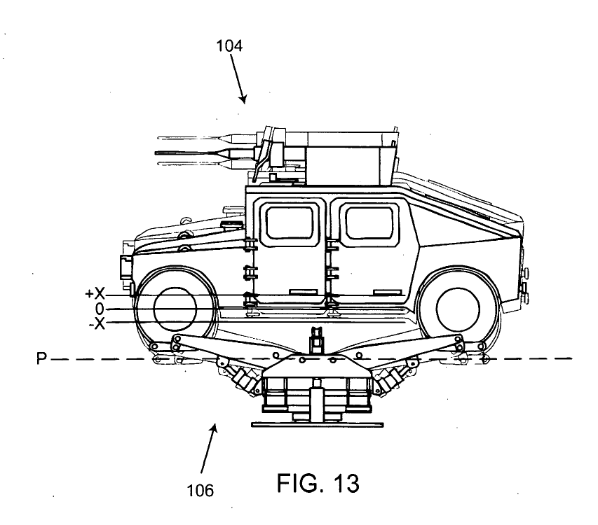

Referring to FIG. 13, vehicle 104 can be raised and lowered by swing arms 126 and cylinders 128 to simulate travel over terrain. Generally, vehicle 104 and simulation system 106 may move vertically from a central position and between low (−X) and high (+X) extremities, for example up to about 6″ in either direction, up to about 8″, up to about 4″, or another distance. The lower extremity may be below a platform level P of the trailer and the platform may have an opening to accommodate such movement. According to various exemplary embodiments, each swing arm 126 may move independently from the other swing arms, two of swing arms 126 (e.g., front two, back two, side two) may move in unison and independent of the other two, or each swing arm 126 may move in unison with the other swing arms.

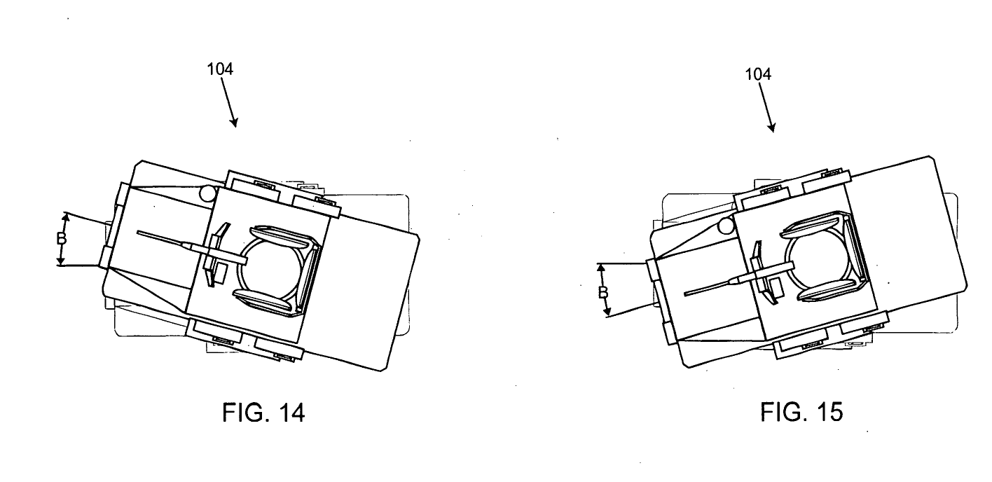

Referring to FIGS. 14 and 15, vehicle 104 can be rotated by rotational turret 136, sing arm 138, and support roller 140 to simulate when vehicle 104 turns. Generally, vehicle 104 and simulation system 106 may rotate left or right up to B degrees, for example up to about 15 degrees, up to about 45 degrees, up to about 180 degrees, or another angle.

Simulation system 100 may include a comprehensive evaluation system to measure the training effectiveness and impact of the individual components and allow follow-up training of the users or modifications of the simulation system 100.

Simulation system 100 is a new achievement in immersive simulation and can provide training objectives previously unavailable. Simulation system 100 can better prepare soldiers for conditions they will face in theater. Simulation system 100 can provide crucial knowledge to the warfighter or soldier to hone his or her skills at threat detection and to train him or her to overcome and remain effective in an IED event if one should occur. Simulation system 100 can train people well enough to save lives and continue to provide outstanding and critical training to soldiers.

For purposes of this disclosure, high definition video may be any video having 720 vertical lines of resolution or more, such as 720p, 1080i, 1080p, and 2160p video formats or any other format of past, present, or future design having at least 720 vertical lines of resolution. A lower case “p” generally denotes progressive scanning while a lower case “i” denotes interlaced scanning or interlacing. Progressive scanning may include displaying, storing, or transmitting moving images in which the lines of each frame are drawn in sequence. Interlaced scanning may include displaying, storing, or transmitting moving images in which the odd and even lines of each frame are alternately drawn. 720p video formats are generally referred to as having a resolution of about 1280×720 (width×height), but may have approximate native resolutions of 1024×768, 1280×720, 1366×768, or 1248×702 and may display up to about 1.1 megapixels. 1080i video formats are generally referred to as having a resolution of about 1920×1080, but may have approximate native resolutions of 1920×1080, 1280×1080, or 1440×1080 and may display up to about 1.6 megapixels. 1080p video formats are generally referred to as having a resolution of about 1920×1080, but may have approximate native resolutions of 1920×1080 or 1888×1062 and may display up to about 2.1 megapixels. 2160p video formats are generally referred to as having a resolution of about 3840×2160 and may display up to about 8.3 megapixels. High definition video may include a variety of screen aspect ratios, for example approximately 3:2, 4:3, 16:9, 1.66:1, 1.85:1, 2.39:1, 2.40:1, 2.75:1, or any other aspect ratio.

The term live action video is generally used to mean any video footage or imagery that is recorded at an actual event, location, or scenario and that is not computer generated (CGI). High definition audio generally includes audio that is capable of playing back more channels at higher quality than previous integrated audio codecs (e.g., AC97), for example Dolby 5.1 digital audio, Intel HD audio, DTS audio, etc. Such high definition audio specifications may be capable of delivering 192 kHz/32-bit quality for two channels and 96 kHz/32-bit for up to eight channels.

While the detailed drawings, specific examples, detailed algorithms, and particular configurations given describe preferred and exemplary embodiments, they serve the purpose of illustration only. The inventions disclosed are not limited to the specific forms shown. For example, the methods may be performed in any of a variety of sequence of steps or according to any of a variety of mathematical formulas. The hardware and software configurations shown and described may differ depending on the chosen performance characteristics and physical characteristics of the simulation system. For example, the type of system components and their interconnections may differ. The systems and methods depicted and described are not limited to the precise details and conditions disclosed. Any flow charts show preferred exemplary operations only. The specific data types and operations are shown in a non-limiting fashion. Furthermore, other substitutions, modifications, changes, and omissions may be made in the design, operating conditions, and arrangement of the exemplary embodiments without departing from the scope of the invention as expressed in the appended claims.

What is claimed is:

1. A simulation system for providing a simulated environment to at least one user in a simulation area, comprising:
a video system configured to provide high definition video of the simulated environment across a field of view of the user, the video system providing high definition live action video;
an audio system configured to provide high definition audio related to the provided high definition video of the simulated environment; and
a motion system configured to move the at least one user on x, y, and z axes to simulate movement in the simulated environment.
wherein a controller affects the simulated environment by controlling the simulation vehicle in real-time in response to verbal and/or non-verbal actions by the user or controller, the motion system moving to simulate the environment, the audio system providing vehicle audio, and the video system providing video based on user control of the vehicle.

2. The simulation system of claim 1, wherein the controller affects the simulated environment by interlacing real-time control and preprogrammed sequences.

3. The simulation system of claim 1, wherein the video system comprises a screen for receiving a projection of the high definition video, the screen providing at least a 270 degree field of view to the at least one user.

4. The simulation system of claim 1, wherein the simulation system provides a simulation of usage of a vehicle, the motion system moving to simulate the vehicle traveling over terrain, the audio system providing vehicle audio, and the video system providing video based on user control of the vehicle.

5. The simulation system of claim 3, wherein the at least one user comprises multiple users, each user having a different seating position within the vehicle.

6. The simulation system of claim 3, wherein the simulation system simulates presence of improvised explosive devices for user detection and avoidance.

7. The simulation system of claim 5, wherein detonation of the improvised explosive devices causes the vehicle to move abruptly, a visual representation of the explosion to be provided by the video system, and an audio representation of the explosion to be provided by the audio system.

8. The simulation system of claim 1, wherein the video system is configured to superimpose images on the provided high definition live action video.

9. The simulation system of claim 1, wherein the video system is configured to change between video scenes by providing transitional video based on environmental conditions or effects.

10. The simulation system of claim 1, wherein the simulation provides training scenarios to the at least one user.

11. The simulation system of claim 1, further comprising:
a control system configured to provide the simulated environment to the video system for rendering, to the audio system for playback, and to the motion system for mechanically moving the at least one user, the control system being controlled by an operator located external to the simulation area.

12. A simulator for providing a simulated training environment to at least one user in a simulation vehicle, comprising:
a video system configured to provide high definition video of the simulated environment at across a field of view of the user, the video system providing high definition live action video;
an audio system configured to provide high definition audio related to the provided high definition video of the simulated environment; and
a motion system configured to move the vehicle on x, y, and z axes to simulate movement in the simulated environment,
wherein a controller affects the simulation environment by controlling the simulation vehicle in response to verbal and/or non-verbal actions by the user, the motion system moving to simulate the vehicle traveling over terrain, the audio system providing vehicle audio, and the video system providing video based on user control of the vehicle.

13. The simulator of claim 1, wherein the video system comprises a screen for receiving a projection of the high definition video, the screen providing at least a 270 degree field of view to the at least one user.

14. The simulator of claim 1, wherein the vehicle is a land, air, or sea vehicle.

15. The simulator of claim 1, wherein the at least one user comprises multiple users, each user having a different seating position within the vehicle.

16. The simulator of claim 1, wherein the simulation system simulates presence of improvised explosive devices for user detection and avoidance.

17. The simulator of claim 15, wherein detonation of the improvised explosive devices causes the vehicle to move abruptly, a visual representation of the explosion to be provided by the video system, and an audio representation of the explosion to be provided by the audio system.

18. The simulator of claim 1, wherein the video system is configured to superimpose images on the provided high definition live action video.

19. The simulator of claim 1, further comprising:
a control system configured to provide the simulated environment to the video system for rendering, to the audio system for playback, and to the motion system for mechanically moving the at least one user, the control system being controlled by an operator located external to the simulation area.

20. An apparatus for providing a simulated environment to at least one user in a simulation area, comprising:
means for providing high definition video of the simulated environment across a field of view of the user, the high definition video comprising live action video;
means for providing high definition audio related to the provided high definition video of the simulated environment; and
means for moving the at least one user on x, y, and z axes to simulate movement in the simulated environment.
